(19) United States
(12) Patent Application Publication
(10) Pub. No.: US 2026/0357800 A1
(43) Pub. Date: Nov. 12, 2026

(54) WEARABLE DEVICE AND METHOD OF CONTROLLING AIR BLOWING DEVICE

(71) Applicant: Sony Interactive Entertainment Inc., Tokyo (JP)

(72) Inventors: Yasushi Okumura, Tokyo (JP); Akihito Nishiike, Kanagawa (JP); Kentaro Yoshida, Kanagawa (JP); Kyosuke Uchida, Tokyo (JP); Koichi Shiono, Kanagawa (JP)

(73) Assignee: Sony Interactive Entertainment Inc., Tokyo (JP)

(21) Appl. No.: 19/664,769

(22) Filed: Apr. 30, 2026

Related U.S. Application Data
(60) Provisional application No. 63/802,735, filed on May 9, 2025.

(51) Int. Cl. F04B 49/06; A63F 13/28; A63F 13/52; A63F 13/98; F04B 39/12; F04B 45/047

(52) U.S. Cl. CPC F04B 49/065; A63F 13/28; A63F 13/52; A63F 13/98; F04B 39/12; F04B 45/047; A63F 2300/302; F04B 2207/01

(57) ABSTRACT

A wearable device is worn about a neck of a user. The wearable device includes: a communication unit configured to receive a control signal from an external apparatus; a plurality of air blowing devices configured to supply air to the neck or a part above the neck of the user; and a control unit configured to control the air blowing devices based on the control signal received.

### TECHNICAL FIELD

The present disclosure relates to technology for supplying air to a user.

### BACKGROUND ART

A head mounted display (HMD) is worn on the head of a user and provides a video world of virtual reality (VR) to the user. The user wearing the HMD can operate the game controller to perform various inputs to a video space provided by the game. Since the HMD provides a VR image to the entire field of view of the user, the user's sense of immersion in the video world can be enhanced.

### SUMMARY

### Technical Problem

Not only in games but also in various applications other than games, there have been various ideas for enhancing the sense of immersion of users. The present disclosing party has focused on the possibility of wearable devices and has conducted studies into realizing a technology for increasing the sense of immersion and the sense of presence for a user.

### Solution to Problem

An aspect of the present disclosure is a wearable device worn about a neck of a user, the wearable device including: a communication unit configured to receive a control signal from an external apparatus; a plurality of air blowing devices configured to supply air to the neck or a part above the neck of the user; and a control unit configured to control the air blowing devices based on the control signal received.

Another aspect of the present disclosure is a method of controlling an air blowing device installed in a wearable device, the method including controlling movement of a player character in a virtual space based on a user operation input; identifying a positional relationship between a player character and an object different from the player character; generating a control signal for controlling driving of each of a plurality of air blowing devices installed in the wearable device worn about a neck of a user based on the positional relationship identified; and transmitting the control signal generated to the wearable device.

It is to be noted that any combination of the above component elements and any conversion of the expression of the present disclosure between a method, an apparatus, a system, a computer program, a storage medium storing a computer program in a readable manner, a data structure, and the like are also valid as an aspect of the present disclosure.

### BRIEF DESCRIPTION OF DRAWINGS

FIG. 1 is a diagram illustrating a configuration example of an information processing system according to an example.

FIG. 2 is a diagram illustrating an example of an external shape of an HMD.

FIG. 3 is a diagram illustrating functional blocks of the HMD.

FIG. 4 is a diagram illustrating an example of an external shape of a wearable device.

FIG. 5 is a diagram illustrating functional blocks of the wearable device.

FIG. 6 is a diagram illustrating functional blocks of an information processing apparatus.

FIG. 7 is a diagram illustrating an example of a displayed game image.

FIG. 8 is a diagram illustrating a state where a player character has opened a door.

FIG. 9 is a diagram illustrating an example of an arrangement of a plurality of air blowing devices in the wearable device.

FIG. 10 is a diagram illustrating a state of a next room that the player character has entered.

(a) of FIG. 11 is a diagram illustrating a positional relationship between the player character and an enemy character. (b) of FIG. 11 is a diagram for explaining a control signal.

(a) of FIG. 12 is a diagram illustrating a positional relationship between the player character and the enemy character. (b) of FIG. 12 is a diagram for explaining a control signal.

FIG. 13 is a diagram illustrating a state in which the enemy character is approaching the back of the player character.

### DESCRIPTION OF EMBODIMENTS

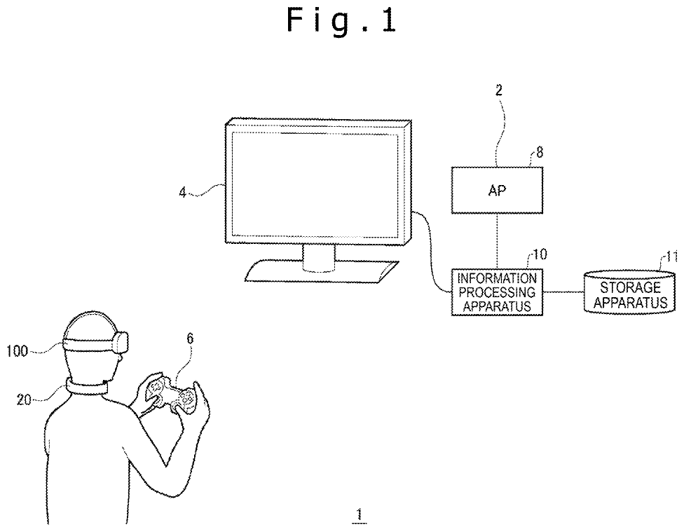

FIG. 1 is a diagram illustrating a configuration example of an information processing system 1 according to an example. The information processing system 1 is a game system including an information processing apparatus 10 that executes an application such as a game, a head mounted display (HMD) 100 that is worn on the head of a user, a wearable device 20 that is worn about the neck of the user, an input apparatus 6 that is operated by the user with fingers, a storage apparatus 11, and an output apparatus 4 that outputs images and sound. The output apparatus 4 may be a television. In the example, the HMD 100 is an example of a display apparatus that displays images, and the information processing system 1 may include VR goggles, AR glasses, smart glasses, or the like instead of the HMD 100. The information processing apparatus 10 is connected to an external network 2 such as the Internet via an access point (AP) 8.

The storage apparatus 11 stores application software such as game software. The information processing apparatus 10 may download game software from a content server (not illustrated) to the storage apparatus 11 via the network 2. The information processing apparatus 10 executes game software (hereinafter, also simply referred to as “game”) based on an operation input by a user, generates image data and audio data for the game, and supplies these to the HMD 100. The information processing apparatus 10 and the HMD 100 may be connected by a known wireless communications protocol or may be connected by a cable.

The HMD 100 is a display apparatus that displays images on a display panel positioned in front of the eyes of a user when the user wears the HMD 100 on the head. The HMD 100 separately displays an image for the left eye on a display panel for the left eye and an image for the right eye on a display panel for the right eye. These images constitute parallax images viewed from the left and right viewpoints, thus realizing stereoscopic vision. Since the user views the display panel through optical lenses, the information processing apparatus 10 supplies parallax image data in which the optical distortion caused by the lenses is corrected to the HMD 100.

Although the output apparatus 4 is not necessary for the user wearing the HMD 100, the output apparatus 4 is prepared to allow another user to view the display image of the output apparatus 4. The information processing apparatus 10 may cause the output apparatus 4 to display the same image as the image being viewed by the user wearing the HMD 100 or may cause the output apparatus 4 to display a different image. For example, in a case where the user wearing the HMD 100 and another user are playing a game together, the game image from a character viewpoint of the other user may be displayed from the output apparatus 4.

Although the user wears the HMD 100 on the head to play the game in the example, in a modification example, the user may not wear the HMD 100 on the head and may play the game while viewing the game image displayed on the output apparatus 4. The display apparatus that displays the game image may be a display apparatus of a PC or a display apparatus of a mobile device.

The information processing apparatus 10 and the input apparatus 6 may be connected by a known wireless communications protocol or may be connected by a cable. The input apparatus 6 includes a plurality of operation members such as operation buttons and an analog stick, and the user operates the operation members with fingers while holding the input apparatus 6. When the information processing apparatus 10 executes a game, the input apparatus 6 is used as a game controller.

In the game of the example, information (operation input) obtained by the user operating the operation member of the input apparatus 6 is reflected in the movement of the player character in the virtual three-dimensional space. The game may use the operation input of the left analog stick for movement processing for the player character, and use the operation input of the right analog stick for the line-of-sight direction changing processing for the player character. Note that in the case where an inertial measurement unit (IMU) is provided in the input apparatus 6, sensor data measured by the IMU may be periodically transmitted to the information processing apparatus 10, and the game may treat the sensor data of the IMU as an operation input of the input apparatus 6 and reflect the operation input in the motion (movement, change in the line-of-sight direction, and the like) of the player character.

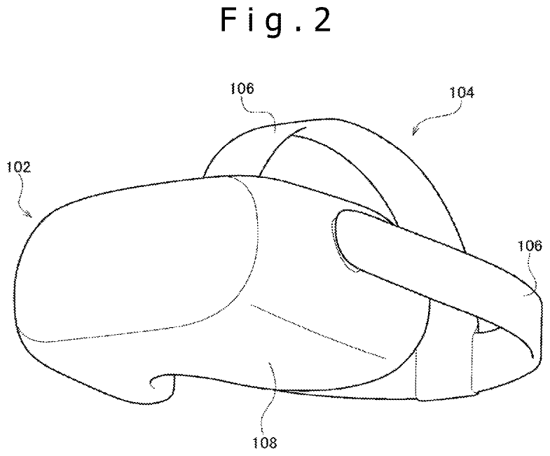

FIG. 2 illustrates an example of the external shape of the HMD 100. The HMD 100 is constituted by an output portion 102 and a fixing portion 104. The fixing portion 104 includes a mounting component 106 that is worn by the user on the head of the user to mount the HMD 100. The mounting component 106 includes a material or structure that allows the length to be adjusted to fit the circumference of the user's head.

The output portion 102 includes a housing 108 having a shape that covers the left and right eyes when the user is wearing the HMD 100 and internally includes a display panel that faces the eyes when the user wears the HMD 100. The display panel may be a liquid crystal panel, an organic EL panel, or the like. The housing 108 further internally includes a pair of left and right optical lenses that are located between the display panel and the user's eyes and enlarge the user's viewing angle. The HMD 100 may further include speakers and earphones at positions corresponding to the ears of the user and may be configured to be connected to an external headphone.

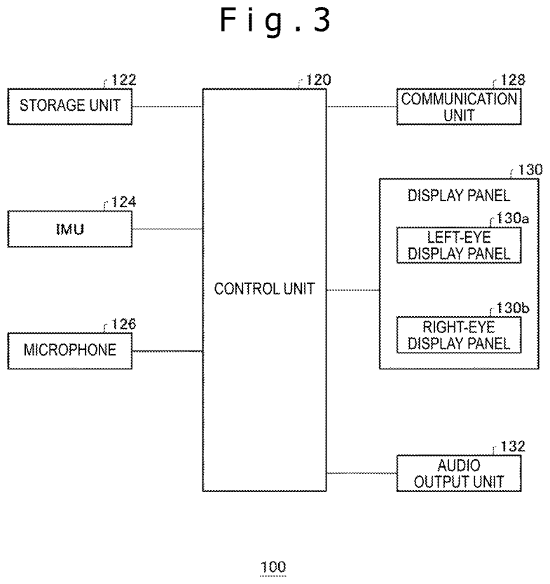

FIG. 3 illustrates the functional blocks of the HMD 100. A control unit 120 is a main processor that processes and outputs various data such as image data, audio data, and sensor data and commands. A storage unit 122 temporarily stores data, commands, and the like to be processed by the control unit 120. An IMU 124 obtains sensor data relating to the motion of the HMD 100. The IMU 124 may include at least a three axis acceleration sensor and a three axis angular velocity sensor. The IMU 124 detects the values of the respective axial components (sensor data) at a predetermined cycle (for example, 800 Hz).

A communication unit 128 transmits the data output from the control unit 120 to the external information processing apparatus 10 by wired or wireless communication via a network adapter or an antenna. The communication unit 128 receives data from the information processing apparatus 10 and outputs the data to the control unit 120.

When the control unit 120 receives game image data from the information processing apparatus 10, the control unit 120 supplies the game image data to the display panel 130 for display, and when the control unit 120 receives the game audio data from the information processing apparatus 10, the control unit 120 supplies the game audio data to an audio output unit 132 for output as audio. The display panel 130 includes a left-eye display panel 130a and a right-eye display panel 130b, and a pair of parallax images are displayed on the display panels. The control unit 120 causes the sensor data from the IMU 124 and the audio data from a microphone 126 to be transmitted from the communication unit 128 to the information processing apparatus 10.

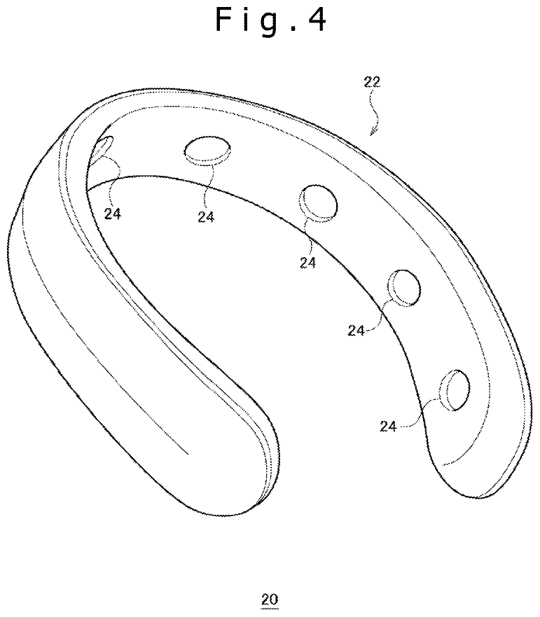

FIG. 4 illustrates an example of an external shape of the wearable device 20. The wearable device 20 is an air blower that is worn about the neck of the user and supplies air to the neck or a part (face or head) above the neck of the user. The wearable device 20 includes a curved neckband-shaped housing 22, and a plurality of air blowing holes 24 for discharging an air flow to the user are formed on an inner peripheral surface of the housing 22.

Inside the neckband-shaped housing 22, a plurality of air blowing devices are arranged at different positions in the circumferential direction. The plurality of air blowing devices are disposed at positions corresponding to the plurality of air blowing holes 24 and supply air from the air blowing holes 24 to the user.

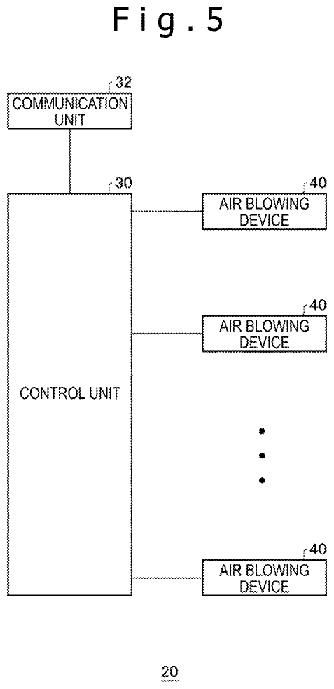

FIG. 5 illustrates functional blocks of the wearable device 20. The wearable device 20 includes a control unit 30, a communication unit 32, and a plurality of air blowing devices 40. The plurality of air blowing devices 40 are disposed at different positions in the housing 22 and supply air in different directions to the user. The plurality of air blowing devices 40 are preferably disposed at substantially the same angular intervals in the circumferential direction in the housing 22. For example, the plurality of air blowing devices 40 are disposed at intervals of 30 degrees in the circumferential direction and supply air in different directions to the user. The angular interval is not limited to 30 degrees and may be another angle. The plurality of air blowing devices 40 may be disposed at different angular intervals in the circumferential direction.

The communication unit 32 is connected to the information processing apparatus 10, which is an external apparatus, by wired or wireless communication via a network adapter or an antenna. In order to eliminate the inconvenience of handling cables, it is preferable that the communication unit 32 can be connected to the information processing apparatus 10 by a known wireless communication protocol. The information processing apparatus 10 generates a control signal according to the situation of the game and transmits the control signal to the wearable device 20. The control signal is a signal for controlling the driving of the air blowing devices 40, and when the communication unit 32 receives the control signal, the communication unit 32 supplies the control signal to the control unit 30. The control unit 30 controls the driving of the plurality of air blowing devices 40 based on the control signal. The information processing apparatus 10 generates a control signal for supplying air in accordance with a game scene to a user who is playing the game.

The air blowing device 40 may be a blower including a piezoelectric element, and the plurality of air blowing devices 40 may be configured as a blower array. The air blowing devices 40 move the diaphragm by ultrasonic vibration of the piezoelectric element to perform suction and discharge of air at high speed, realizing high drive response. This allows the air blowing devices 40 to supply air according to the game scene to the neck or a part (face or head) above the neck of the user without delay with respect to a change in the game scene.

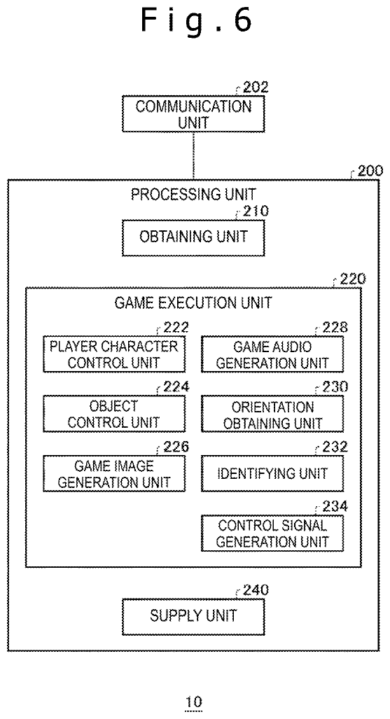

FIG. 6 illustrates the functional blocks of the information processing apparatus 10. The information processing apparatus 10 includes a processing unit 200 and a communication unit 202, and the processing unit 200 includes an obtaining unit 210, a game execution unit 220, and a supply unit 240. The game execution unit 220 includes a player character control unit 222, an object control unit 224, a game image generation unit 226, a game audio generation unit 228, an orientation obtaining unit 230, an identifying unit 232, and a control signal generation unit 234. The communication unit 202 receives operation information of the operation member transmitted from the input apparatus 6 and supplies the operation information to the obtaining unit 210. The communication unit 202 receives sensor data transmitted from the HMD 100 and supplies the sensor information to the obtaining unit 210.

The functions of the component elements in the information processing apparatus 10 may be realized in circuitry or processing circuitry including a general-purpose processor, a specific-purpose processor, an integrated circuit, ASICs (Application Specific Integrated Circuits), a CPU (Central Processing Unit), a conventional circuit, and/or a combination thereof, configured or programmed to realize the functions described in the present specification. The processor is regarded as circuitry or processing circuitry including a transistor and other circuits. The processor may be a programmed processor that executes a program stored in memory.

In the present specification, circuitry, a unit, or a means is hardware programmed to realize a described function or hardware that executes the function. The hardware may be any hardware disclosed herein or any hardware known to be programmed or otherwise capable of executing the described functions.

In a case where the hardware is a processor that is considered to be a type of circuitry, the circuitry, the means, or the unit may be a combination of hardware and software used to configure the hardware and/or the processor.

When the obtaining unit 210 obtains the operation information transmitted from the input apparatus 6 and the sensor data transmitted from the HMD 100, the obtaining unit 106 supplies the operation information and the sensor information to the game execution unit 220 as operation inputs of the user for the game. The game execution unit 220 in the example executes a game in which a player character operated by a user escapes from a house.

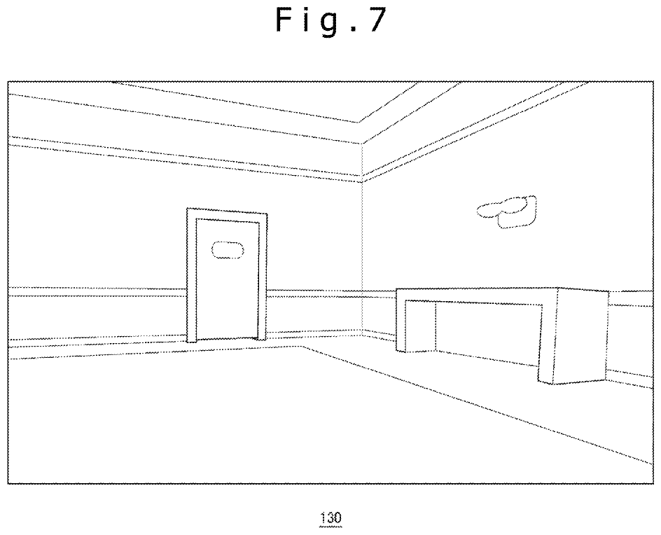

FIG. 7 illustrates an example of a game image displayed on the display panel 130. The game execution unit 220 of the example executes a game program based on an operation input of a user and performs arithmetic processing for moving a player character in a house which is a three-dimensional virtual reality space. The player character control unit 222 controls the movement of the player character in the house and moves the player character based on the operation input of the left analog stick in the input apparatus 6.

The object control unit 224 executes processing of causing an object different from the player character to move in the house. Here, the object may be a character operated by an enemy or ally user or may be a non-player character (NPC) not operated by a player. The object control unit 224 basically executes processing of moving a dynamic object that can move in the house, but may execute processing of operating a static object that cannot move, for example, processing of operating an object that generates wind, sound, or the like.

The orientation obtaining unit 230 identifies the orientation of the HMD 100 by using the sensor data transmitted from the HMD 100 and determines the line-of-sight direction of the user. The game image generation unit 226 of the example may determine the line-of-sight direction of the player character by using the line-of-sight direction of the user identified by the orientation obtaining unit 230 and the line-of-sight direction identified by the operation input of the right analog stick in the input apparatus 6.

The game image generation unit 226 includes a GPU (Graphics Processing Unit) that executes rendering processing and the like, receives the result of arithmetic processing in the virtual reality space, and generates a game image captured from the virtual camera position in the virtual reality space. The game image generation unit 226 of the example generates a game image from a first person viewpoint and generates a field-of-view image of a player character based on the line-of-sight direction of the player character. The game image generation unit 226 of the example generates a pair of parallax images including a left-eye VR image and a right-eye VR image, and the game audio generation unit 228 generates a game audio.

In the game scene illustrated in FIG. 7, the player character walks around the room in the house and looks for a hint for how to escape. A door is present in front of the player character, and another room exists on the other side of the door. The user can enter the next room by operating the player character to approach the door and open the door.

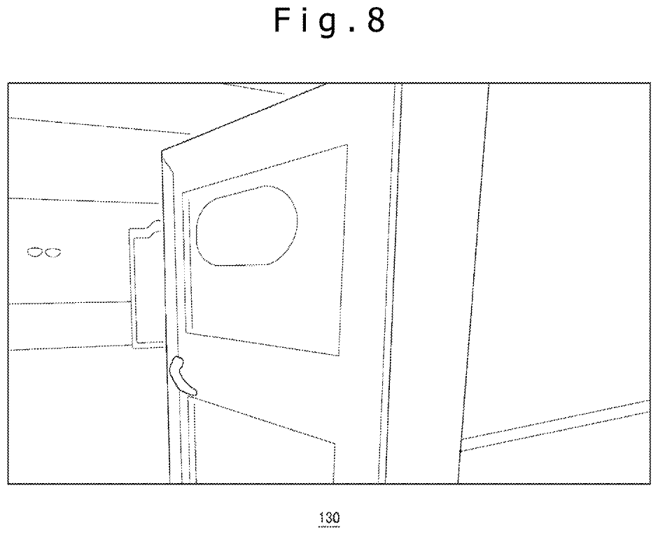

FIG. 8 illustrates a state where the player character has opened the door. The object control unit 224 may move the door, which is an object, so as to open when the player character pushes the door. When the door is opened, the control signal generation unit 234 generates a control signal for controlling the driving of the plurality of air blowing devices 40 to emulate wind blowing from the front of the user.

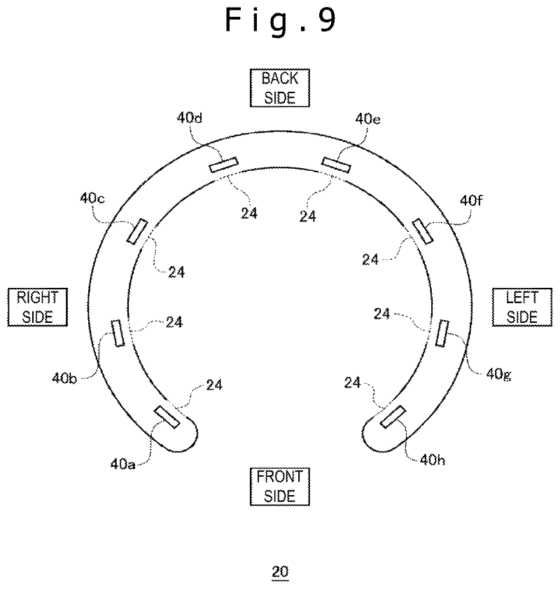

FIG. 9 illustrates an example of the arrangement of the plurality of air blowing devices 40 in the wearable device 20. In this example, eight air blowing devices 40a to 40h are arranged at substantially the same angular intervals inside the housing 22. Each air blowing device 40 is provided so as to discharge an air flow in a direction substantially perpendicular to the inner peripheral surface of the housing 22 and/or in a direction diagonally upward with respect to the substantially perpendicular direction. In FIG. 9, the front side, the left side, the back side, and the right side indicate directions based on the face of the user when the user wears the wearable device 20 about the neck, and the front direction of the face is defined as the “front side”. When the user wears the wearable device 20, the air blowing devices 40a and 40h are located on the front side, the air blowing devices 40g and 40f are located on the left side, the air blowing devices 40e and 40d are located on the back side, and the air blowing devices 40c and 40b are located on the right side. The control signal generation unit 234 recognizes the arrangement configuration of the plurality of air blowing devices 40a to 40h mounted on the wearable device 20. In yet another example, nine or more air blowing devices 40 may be arranged, or seven or less air blowing devices 40 may be arranged.

When the player character opens the door, the identifying unit 232 identifies the direction to supply air to the user. In the example, when the door is opened, the identifying unit 232 determines to blow air at the user from the front. The identifying unit 232 may identify the direction to supply the air to the user by identifying the direction of the wind blowing against the player character in the three-dimensional virtual reality space. There are various techniques for causing wind to blow in a three-dimensional virtual reality space, and for example, an object (wind object) that generates wind may be arranged in the room beyond the opened door, and when the door is opened, the object control unit 224 may cause the wind object to operate, causing wind to be blown at the player character. Here, the identifying unit 232 identifies that wind is blowing at the player character from the front side and thus determines to blow air at the user from the front.

When the identifying unit 232 supplies the determined wind direction to the control signal generation unit 234, the control signal generation unit 234 determines the air blowing devices 40 to blow air from the front of the user based on the supplied wind direction and generates a control signal for driving the air blowing devices 40. In this example, the control signal generation unit 234 determines to drive the air blowing devices 40a and 40h in order to supply air from the front of the user and generates control signals for driving the air blowing devices 40a and 40h. At this time, the control signal generation unit 234 generates a control signal for not driving the air blowing devices 40 other than the air blowing devices 40a and 40h. The supply unit 240 transmits the control signal generated by the control signal generation unit 234 from the communication unit 202 to the wearable device 20.

In the wearable device 20, when the communication unit 32 receives the control signal, the control unit 30 controls the driving of the plurality of air blowing devices 40 based on the control signal. In this example, the control unit 30 performs control so as to drive the air blowing devices 40a and 40h and not to drive the other air blowing devices 40b to 40g, so that the user is supplied with air only from the air blowing devices 40a and 40h. This allows the user to feel the air blowing from the front and perceive that, by the player character opening the door, wind is flowing from the room beyond the opened door.

Note that the control signal generation unit 234 may generate a control signal using a time constant set for the object. As described above, the air blowing devices 40 move the diaphragm by ultrasonic vibration of the piezoelectric element, and thus can perform suction and discharge air at high speed, allowing air to be supplied instantly. Thus, in a case where a time constant is not used, the air blowing devices 40a and 40h are driven at the moment when the player character opens the door, and the air is supplied to the front side of the neck and/or the face of the user. Although this is not problematic, in a case where it is desired to supply air gently, the control signal generation unit 234 may generate a control signal so that air is supplied gently using a time constant set for an object (here, a wind object). The magnitude of the time constant may be set per object.

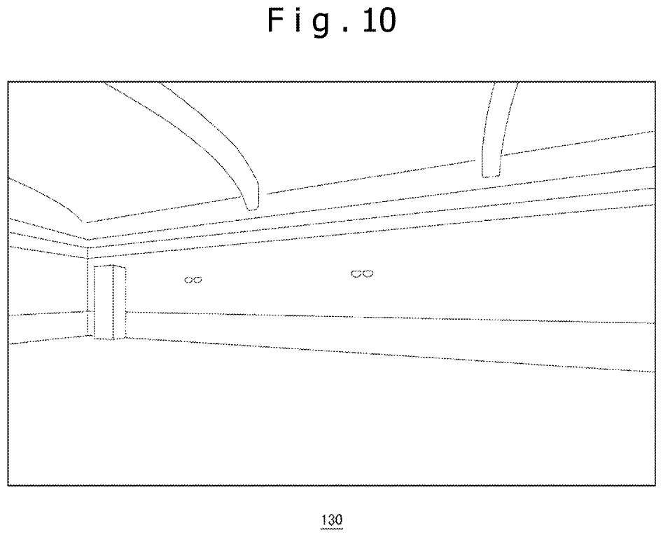

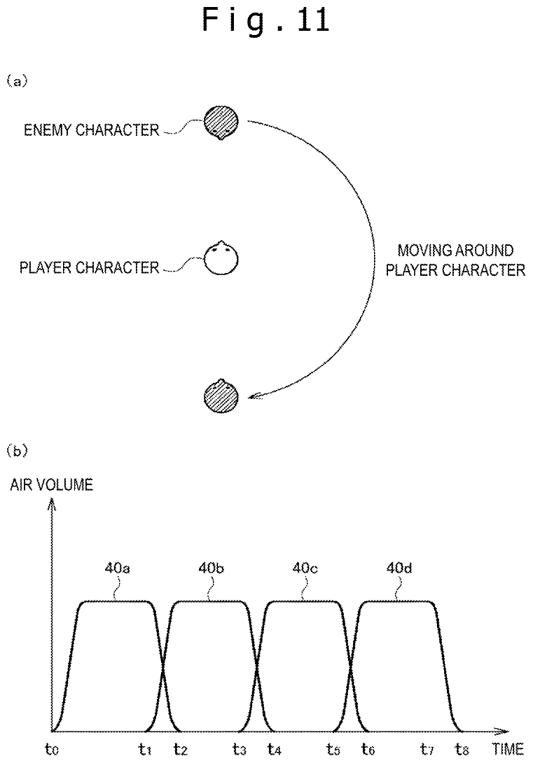

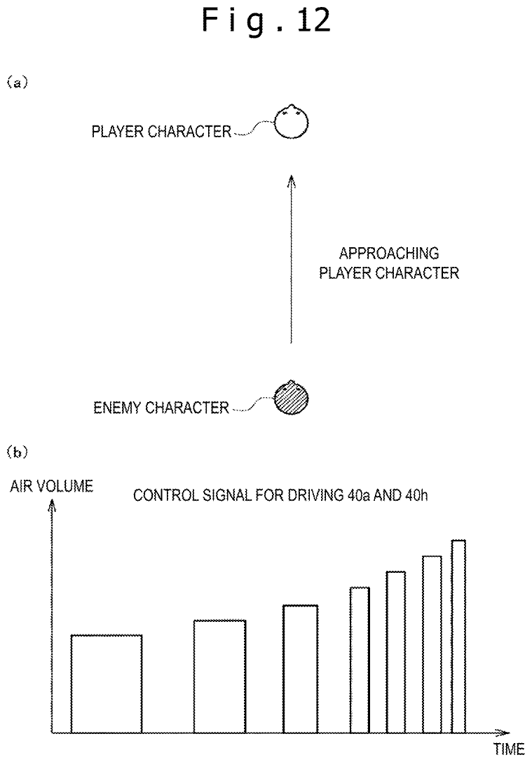

FIG. 10 illustrates the state of the next room that the player character has entered. When the room is dark, the user cannot check the state of the room well. Thus, when the enemy character is approaching the player character, the user may not perceive the approaching enemy character only by viewing the game image displayed on the display panel 130.

In the game of the example, the user is notified of the presence of a dynamic object such as an enemy character using air. For example, the user may be made to feel the presence of the enemy character by air being supplied from the air blowing devices 40 corresponding to the position of the enemy character.

(a) of FIG. 11 illustrates the positional relationship between the player character and the enemy character as viewed from above. In this example, the enemy character is illustrated rotating clockwise around the player character while keeping a certain distance. Here, it is assumed that the player character is stationary. In the initial state, the player character is facing the enemy character, but since the inside of the room is dark, the user has difficulty in visually perceiving the enemy character.

The identifying unit 232 has a function of identifying the positional relationship between the player character and an object (here, the enemy character) different from the player character. The identifying unit 232 generates a control signal for controlling driving each of the plurality of air blowing devices 40 mounted in the wearable device 20 based on the identified positional relationship.

In the example, the identifying unit 232 generates a control signal for controlling driving each of the plurality of air blowing devices 40 based on the direction in which the enemy character is present with respect to the player character. Here, the enemy character serves as a wind generation source that generates wind toward the player character, and the identifying unit 232 identifies the direction from the position of the enemy character toward the position of the player character as the direction of the wind and determines the direction of the air to be supplied to the user.

As illustrated in (a) of FIG. 11, the wind is initially blowing against the player character from the front side (front) of the player character. Then, as the enemy character as the wind generation source rotates clockwise around the player character, the wind gradually starts to blow from the right side of the player character, and finally, when the enemy character has moved around to the back of the player character, the wind blows from directly behind the player character.

FIG. 11B is a diagram for explaining the control signal generated by the control signal generation unit 234. Referring to the arrangement of the air blowing devices 40 illustrated in FIG. 9, the control signal generation unit 234 generates control signals for driving the air blowing devices 40a, 40b, 40c, and 40d in this order.

Specifically, the control signal generation unit 234 generates a control signal for starting the driving of the air blowing device 40a at time t₀, starting to limit the air discharge amount at time t₁, and ending the driving at time t₂. Also, the control signal generation unit 234 generates a control signal for starting the driving of the air blowing device 40b at time t₁, starting to limit the air discharge amount at time t₃, and ending the driving at time t₄. Also, the control signal generation unit 234 generates a control signal for starting the driving of the air blowing device 40c at time t₃, starting to limit the air discharge amount at time t₅, and ending the driving at time to. Also, the control signal generation unit 234 generates a control signal for starting the driving of the air blowing device 40d at time t₅, starting to limit the air discharge amount at time t₇, and ending the driving at time t₈. The supply unit 240 transmits the control signal generated by the control signal generation unit 234 via the communication unit 202 to the wearable device 20.

In the wearable device 20, when the communication unit 32 receives the control signal, the control unit 30 controls the driving of the plurality of air blowing devices 40 based on the control signal. In this example, the control unit 30 performs control to drive the air blowing devices 40a, 40b, 40c, and 40d in this order, so that the user can feel that the wind blowing from the front gradually blows from the right and finally blows from the back. In this example, since the enemy character rotates clockwise around the player character while keeping a certain distance, the air volume supplied to the user may be controlled to be constant. By changing the air direction in this manner, the user can feel the movement of the enemy character rotating around the player character, and it is possible to increase the sense of immersion and the sense of presence of the user.

(a) of FIG. 12 illustrates the positional relationship between the player character and the enemy character as viewed from above. In this example, the enemy character is illustrated approaching the player character from behind. In the example, the identifying unit 232 generates a control signal for controlling driving each of the plurality of air blowing devices 40 based on the distance between the player character and the enemy character. The enemy character serves as a wind generation source that generates wind toward the player character, and the identifying unit 232 may determine to supply more air volume to the user when the distance is shorter. The identifying unit 232 identifies that, when the distance between the player character and the enemy character is far, wind with a small air volume blows against the player character, and as the distance becomes less, the air volume gradually increases.

FIG. 12B is a diagram for explaining the control signal generated by the control signal generation unit 234. Referring to the arrangement of the air blowing devices 40 illustrated in FIG. 9, when an enemy character is present behind the player character, the control signal generation unit 234 generates a control signal for simultaneously driving the air blowing devices 40a and 40h located on the back side of the neck of the user.

The control signal generation unit 234 generates control signals for driving the air blowing devices 40a and 40h so as to achieve air volume corresponding to the distance between the player character and the enemy characters. As illustrated in FIG. 12B, the control signal generation unit 234 generates a control signal for increasing the air volume as the distance decreases. In the example illustrated in FIG. 12B, the control signal generation unit 234 generates a control signal for intermittently generating air in a pulse pattern and shortens the width of the pulse-pattern air and the generation cycle of the air according to the distance.

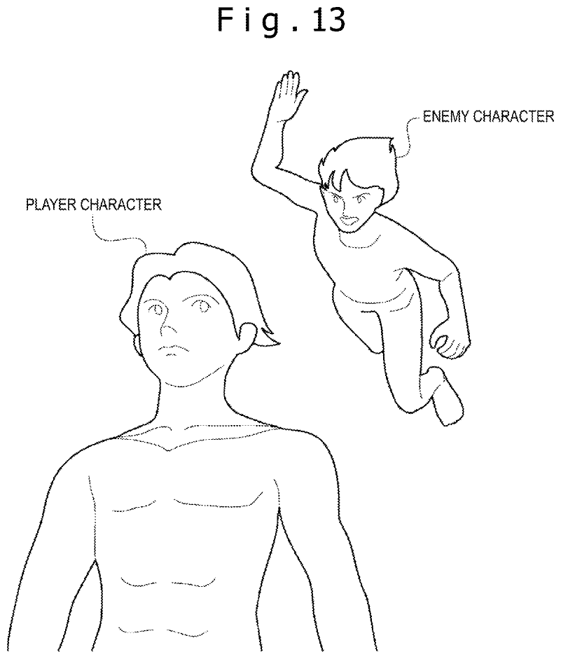

FIG. 13 is a diagram illustrating a state in which an enemy character is approaching the back of a player character. As the enemy approaches, the user feels that the generation cycle of the intermittently blown air has shortened and the air volume has increased, and thus, the user can feel that the enemy is approaching. By generating air in this manner, it is possible to enhance the sense of immersion and the sense of presence of the user.

The present disclosure has been described above based on the examples. The above-described examples are merely examples, and it will be understood by those skilled in the art that various modifications to the combination of the component elements and the processing processes are possible and that such modifications are also within the scope of the present disclosure. In the examples described above, the control signal generation unit 234 generates a control signal based on the positional relationship between a player character and an object, but the control signal may be generated based on movement information indicating a movement speed and/or a movement direction of the player character instead of the positional relationship with the object.

In a modification example, the identifying unit 232 may identify the movement speed of the player character. The movement speed may be a relative speed with respect to the ground (or floor) in the three dimensional virtual reality space. The identifying unit 232 identifies the movement speed of the player character when the player character is walking or running or identifies the movement speed of the player character when the player character is riding in a vehicle (for example, a car, a roller coaster, or the like). The control signal generation unit 234 may generate the control signal so that the greater the movement speed of the player character is, the greater the air volume of the air blown at the user.

The identifying unit 232 may identify the movement direction of the player character. The movement direction may be a relative direction with respect to the front direction of the face. For example, when the player character goes straight, that is, when the player character is moving in the front direction of the face, the identifying unit 232 may identify the movement direction as 0 degrees (that is, the front direction of the face). For example, when the player character moves right while facing the front (so-called crab walking), the identifying unit 232 may identify the movement direction as 90 degrees (that is, the right direction of the face). The identifying unit 232 may identify the movement direction of the player character, and the control signal generation unit 234 may generate a control signal so that the air in the direction opposite to the movement direction blows at the user.

In the game, there may be a performance for making the user feel fear. In the examples, the air supplied to the user is controlled according to the direction in which the enemy character is present and the distance to the enemy character. However, in a modification example, there may be a performance for making the user feel that at least an enemy character is present without the user knowing the location of the enemy character. In this case, the control signal generation unit 234 randomly selects the air blowing devices 40 and generates a control signal for driving the selected air blowing devices 40. A waveform (hereinafter referred to as an “air waveform”) obtained by compiling the air volumes of the air output continuously over time from the air blowing devices 40 may be controlled to be, for example, a sine wave shape, a rectangular wave shape, or other shapes. By employing the air blowing devices 40 that are blowers including a piezoelectric element, it is possible to output an air waveform having any shape. By supplying air to the user from various directions and changing the air volume, the user can recognize that something unknown is present around the user. When there is a performance for making the user feel fear, the control signal generation unit 234 generates a control signal for driving the air blowing devices 40 so as to output a different air waveform every time to make the user feel that a new enemy character different from previous enemies is hiding nearby.

The control signal generation unit 234 may generate a control signal for controlling the driving of the air blowing devices 40 based on speech uttered from the object. When an object (a character different from the player character) speaks in the virtual reality space, the user can hear the voice at a volume corresponding to the distance between the object and the player character from the direction in which the object is present with respect to the player character. At this time, the control signal generation unit 234 may generate a control signal for supplying air to the user from the same direction. The control signal generation unit 234 converts the audio data so as to smooth out the undulations of the audio waveform by passing the audio data through a low-pass filter or the like and generates a control signal for driving the air blowing devices 40 so as to obtain the converted waveform (air waveform). In this manner, the user hears the voice of the object from the direction in which the object is present and the air corresponding to the volume is supplied from the same direction so that the feeling of the presence of the object can be improved and the sense of immersion and the sense of presence of the user can be enhanced.

The control signal generation unit 234 may generate a control signal for controlling the driving of the air blowing devices 40 based on sound emitted from the sound source object, with this not being limited to speech. When a sound is output from a sound source object provided in the virtual reality space, the control signal generation unit 234 may generate a control signal for supplying air to the user from a direction in which the sound source object is present with respect to the player character. For example, in a case where the sound source object outputs a wind sound, the control signal generation unit 234 generates a control signal for actually supplying air, making it possible to enhance the sense of immersion and the sense of presence of the user. In an environment in which the wind violently blows from various directions, the control signal generation unit 234 may randomly select a plurality of the air blowing devices 40 and generate a control signal for driving the selected air blowing devices 40 or may generate a control signal for driving all of the air blowing devices 40, for example. At this time, by controlling the air volumes output from the respective air blowing devices 40 to be different from each other, the user can feel the difference in the air volume depending on the direction, and the sense of presence can be enhanced. In addition, by using various air waveforms, it is possible to improve the environmental representation.

In the examples described above, air is supplied from the wearable device 20 when the user plays a game. However, air may be supplied from the wearable device 20 when an application other than a game is executed.

1. A wearable device suitable for placement around a neck of a user, the wearable device comprising:
one or more processors; and
one or more memories storing executable instructions that, when executed by the one or more processors, cause the wearable device to at least:
receive a control signal from an external apparatus;
supply air to one or more of the neck and a part above the neck of the user; and
control the air blowing devices based on the control signal.

2. The wearable device of claim 1, further comprising:
a housing with a curved neckband-shape, wherein:
plurality of air blowing devices are arranged at different positions in the housing to supply air in different directions.

3. The wearable device of claim 2, wherein;
each one of the plurality of air blowing devices includes a piezoelectric element.

4. The wearable device of claim 1, wherein:
the control signal is received from the external apparatus as generated during execution of an application at the external apparatus.

5. A method of controlling an air blowing device installed in a wearable device, the method comprising:
controlling, at an information processing apparatus, movement of a player character in a virtual space based on a user operation input;
identifying, at the information processing apparatus, a positional relationship between the player character and an object different from the player character;
generating, at the information processing apparatus, a control signal for controlling each one of a plurality of the air blowing devices installed in the wearable device based on the positional relationship as identified; and
transmitting, from the information processing apparatus, the control signal to the wearable device.

6. The method of controlling an air blowing device of claim 5, wherein:
the control signal for controlling driving of each of the plurality of air blowing devices is generated based on a distance in the virtual space between the player character and the object.

7. The method of controlling an air blowing device of claim 5, wherein:
the control signal is generated based on a direction from the player character toward the object.

8. The method of controlling an air blowing device of claim 7, further comprising:
determining presence of another character; and
upon determining presence of the another character, determining location of the another character,
wherein the control signal is generated based on the location of the another character to cause at least one of the plurality of the air blowing devices corresponding to the location of the another character to operate based on the control signal.

9. The method of controlling an air blowing device of claim 8, wherein
the another character is an enemy to the player character in the virtual space.

10. The method of controlling an air blowing device of claim 5, wherein generating the control signal comprises using a time constant set for the object.

11. A method of controlling an air blowing device installed in a wearable device, the method comprising:
controlling, at an information processing apparatus, movement of a player character in a virtual space based on a user operation input;
identifying, at the information processing apparatus, movement information indicating one or more of a movement speed and a movement direction of the player character;
generating, at the information processing apparatus, a control signal for controlling each one of a plurality of air blowing devices installed in the wearable device based on the movement information as identified; and
transmitting, from the information processing apparatus, the control signal to the wearable device.
